(19) United States
(12) Patent Application Publication
(10) Pub. No.: US 2014/0320644 A1
(43) Pub. Date: Oct. 30, 2014

(54) DETERMINATION OF A HEIGHT PROFILE OF THE SURROUNDINGS OF A VEHICLE BY MEANS OF A 3D CAMERA

(71) Applicants: Conti Temic Microelectronic GmbH, Nürnberg (DE); Continental Teves Ag & Co. oHG, Frankfurt (DE)

(72) Inventors: Stefan Hegemann, Wangen (DE); Stefan Heinrich, Achern (DE); Stefan Lüke, Bad Homburg (DE)

(21) Appl. No.: 14/366,052

(22) PCT Filed: Dec. 17, 2012
(86) PCT No.: PCT/DE2012/100384

§ 371 Date: Jun. 17, 2014

(30) Foreign Application Priority Data
Dec. 20, 2011 (DE) 10 2011 056 671.6

(51) Int. Cl. G06T 7/00; H04N 13/02; G06T 7/20; H04N 7/18

(52) U.S. Cl. CPC G06T 7/0034; H04N 7/183; H04N 13/02; G06T 7/204
USPC 348/140

(57) ABSTRACT

The invention relates to a method and a device for determining a height profile of the surroundings of a vehicle by means of a 3D camera. The 3D camera records at least one image of the vehicle's surroundings. The image data of the 3D camera is used to determine whether there is at least one jump in the height curve of the surface of the surroundings transversely to the direction of travel of the vehicle.

### CROSS REFERENCE TO RELATED APPLICATIONS

This application is the U.S. National Phase Application of PCT/DE2012/100384, filed Dec. 17, 2012, which claims priority to German Patent Application No. DE 10 2011 056 671.6, filed Dec. 20, 2011, the contents of such applications being incorporated by reference herein.

### FIELD OF THE INVENTION

The invention relates to a method and a device for determining a height profile of the surroundings of a vehicle by means of a (spatially resolving) 3D camera.

### BACKGROUND OF THE INVENTION

DE 102009033219 A1, which is incorporated by reference, shows a method and a device for determining a road profile of a traffic lane ahead of a vehicle. An image capture device or the vehicle's own motion data is used to determine a road height profile of the traffic lane ahead of the vehicle. Said image capture device can be a camera which is fixedly arranged in the front area of the vehicle and comprises two image recording units. Depending on the determined road height profile, an active chassis control or adaptive dampening system can be controlled.

It has been found that the method and the device according to the state of the art have drawbacks since the known way in which road height profiles of the traffic lane ahead are taken into account is not appropriate to all driving situations.

### SUMMARY OF THE INVENTION

An aspect of the present invention aims to eliminate these drawbacks and to achieve a more reliable evaluation for further driving situations.

This aspect is achieved by recording at least one image of the vehicle's surroundings by means of a 3D camera. The image data of the 3D camera is used to determine whether there is at least one jump in the height curve of the surface of said surroundings transversely to the direction of travel of the vehicle.

Based on the determination of jumps in the height curve transversely to the direction of travel of the vehicle, a complete model of the roadway and the surroundings of the vehicle can be produced, thus enabling a reliable evaluation of almost all driving situations. In particular, it can be determined which area is suitable for driving in case of roads or roadways which are delimited by raised roadside markings or surrounded by sloping ground. In particular, data of the depth-resolved image data of the 3D camera (disparity image) can be transferred into a vehicle-based coordinate system in order to determine the height curve. The result of this transformation is a three-dimensional point cloud. Based on said 3D point cloud, a height map can be generated. To this end, a predefined area ahead of the vehicle can be divided into a predefined number of cells, and a height value can be assigned to each cell. This height value is the highest value of the point cloud within the associated cell and is preferably lower than 1.5 meters. This upper limit serves, in particular, to eliminate very high objects, such as bridges, from the data.

In an advantageous embodiment, the height curve is determined along a plurality of lines running transversely to the direction of travel. These lines are also called scanlines. The height curve is “scanned” along said lines. In particular, the height curve is determined along several lines running transversely to the direction of travel, based on the image data of the 3D camera or a height map produced from said data.

Advantageously, the area of detection in which the height curve is determined along the plurality of lines running transversely to the direction of travel can be limited in accordance with jumps in the height curve determined earlier. If a jump in height is detected in a scanline, this jump in height can be used to reduce the ansatz relating to the area of search to an ansatz which uses this information in the distance and operates on a reduced search field. For example, line sections whose center is at the lateral position of a detected jump in height (e.g. from the adjacent scanline) and whose width is e.g. one meter or 50 cm can be used for scanning. In this way, considerable computation resources can be saved.

Preferably, detected jumps in the height profile of the surroundings of the vehicle (3D edge information from the 3D or depth image) can be described more precisely by combining them with color and/or grayscale image edges determined separately. To evaluate the 3D image data, three data streams of the 3D camera are available, in principle: the image, optical flow and the disparity map (or disparity image). This preferred embodiment is based on the disparity map and the 2D camera image. Both the left and the right camera module can provide a 2D camera image in case of a stereo camera. In the camera image, edges can be detected which may be the edge of the road. However, this information alone is not always reliable since said edges can also be part of objects that do not belong to the group of raised or lowered road edges such as curbstones (tar joints, shadows, etc.). But jumps in the height curve of the surroundings of the vehicle usually also cause edges in the color/grayscale image which is detected e.g. by one of two image recording units of a stereo camera. Using an algorithm for edge detection from the 2D image data, said edges can be determined as color/luminance changes, for example by means of a Canny or Sobel operator. These edges, which have been detected by evaluating the intensity or color of image points, can e.g. be compared with typical characteristics of curbstone structures in order to identify a roadway edge with a changed height level and to take them into account when determining the height profile of the surroundings of the vehicle based on the 3D image data. They serve, for example, to obtain more precise information or check the plausibility of the position or classification of jumps in height. In particular in case of stereo cameras, it is known which 3D image point or which disparity map position or which point in a height map corresponds to a 2D image point which has been provided by an individual image recording unit and assigned to an edge.

In general, there are three different approaches for merging the data from both methods (height jump detection based on 3D and edge detection based on 2D):
a) both detection methods work independently, and the results are fused,
b) the height jump detection function using stereo data detects whether a curbstone is present, and the image is checked for a matching edge; or
c) the 2D image is searched for edges, and the places where suitable edges are present are checked for a jump in height in the depth-resolved data.

The procedure according to method b) has the advantage that only roadside markings which are actually raised/lowered are taken into account as candidates.

Advantageously, edge detection in the 2D image comprises pre-processing (data synchronization, grayscale image conversion and noise reduction) and a contour search where edges are detected by means of a Canny edge operator and then tracked in the forward direction into a larger distance. The starting point is the result of the jumps in height determined earlier from the 3D image data. Finally, contour matching may be performed.

According to an advantageous further development of the invention, at least one roadway edge can be detected taking into account the at least one determined jump in the height curve.

Preferably, a raised roadside marking, in particular a curbstone, is detected based on a predefined minimum height of a jump in the height curve of the surface of the surroundings transversely to the direction of travel of the vehicle.

To this end, it can preferably be determined, based on vehicle data and/or data relating to the surroundings, whether there is a risk that the vehicle will collide with a raised roadside marking. Vehicle data include data from the vehicle sensors, such as the rotational speed sensor, inertial sensors, steering angle sensor, etc., which, in particular, allow the trajectory of the own vehicle to be estimated or determined. Data relating to the surroundings include data from the surroundings of the vehicle, which can be detected or received by/from surroundings sensors or communication devices, etc. The 3D camera also provides data relating to the surroundings. If the trajectory is analyzed using data relating to the surroundings, it can be determined whether there is a risk that the vehicle will collide, e.g. with a curbstone. Based on the height of the curbstone (jump in the height curve), it can also be determined whether it is possible or critical, i.e. not recommended, to cross said curbstone. If there is a risk of collision (and said collision is not recommended), a warning to the driver can be issued, or the vehicle control system may be manipulated in such a manner that the collision is prevented. Said manipulation may, in particular, include a steering and/or braking action. In this way, damage to the vehicle (e.g. wheel rims, tires) can be avoided.

In a preferred embodiment, a lower level of the surroundings adjoining a roadway edge is detected based on a predefined minimum depth of a jump. Vehicle data and/or data relating to the surroundings can be used to determine whether there is a risk that the vehicle will run off the roadway. If so, a warning can be issued, or the vehicle control system may be manipulated in such a manner, that the vehicle is prevented from leaving the roadway. In this way, vehicles can be prevented from running off delimited roadways towards the side.

Advantageously, sloped and/or lowered curbstones can be detected based on changing jumps in height in the direction of travel if there are raised roadside markings, thus enabling the detection of driveways and/or drives running transversely to the roadway.

According to an advantageous embodiment, the vehicle control system is manipulated at least once during a stopping or parking process, so that the vehicle will be positioned parallel to and at a predefined lateral distance to a raised roadside marking. This means the driver enjoys at least partly autonomous parking assistance thanks to the detection of the lateral curbstone.

Busses or other motor vehicle used for passenger transport can also be made to stop at an optimum distance from the curbstone by means of said detection of the curbstone in combination with a steering assistance function which serves to avoid damage to the tires. As a result, it will be easier for passengers to get on or off the vehicle.

The 3D camera is preferably a stereo camera or a photonic mixing device camera or a PMD sensor.

An aspect of the invention further comprises a device for determining a height profile of the surroundings of a vehicle. For this purpose, a 3D camera and evaluation means for detecting a jump in the height curve of the surface of the surroundings transversely to the direction of travel of the vehicle are provided.

### BRIEF DESCRIPTION OF THE DRAWINGS

The invention will now be explained in more detail with reference to figures and an exemplary embodiment.

In the figures:

FIG. 1 shows lines which run transversely to the direction of travel and along which the height curve of the surface of the surroundings of the vehicle is determined;

FIG. 2 shows the height curve of the surface of the surroundings of the vehicle transversely to the direction of travel.

### DETAILED DESCRIPTION OF THE INVENTION

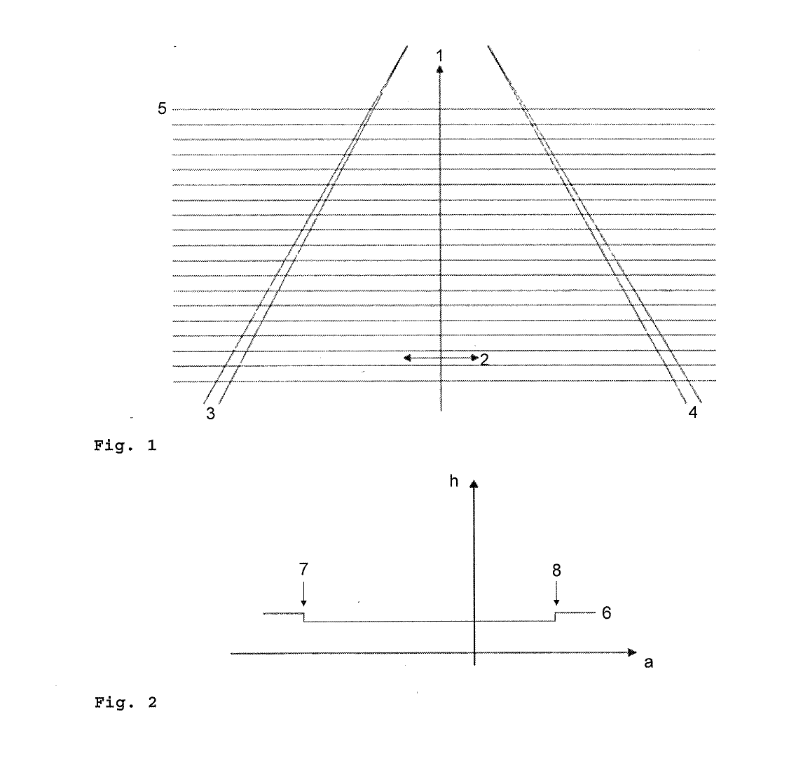

FIG. 1 schematically shows how the height curve is scanned along lines (5) running transversely (2) to the direction of travel (1) of the vehicle. Parallel to the roadway, a left (3) and a right (4) raised roadside marking can be seen. If the vehicle is driven normally, said raised roadside markings (3, 4) extend substantially parallel to the direction of travel (1).

FIG. 2 shows an exemplary height curve (6). The height h is presented as a function of the (transverse) offset a. This height curve (6) includes two jumps (7, 8). The roadway extends between the two jumps (7, 8). The left jump (7) corresponds to a raised roadside marking (3), e.g. the left curbstone. The height of the left curbstone (3) can be determined directly from this curve. The same applies to the right jump (8), which can e.g. be associated with the right curbstone (4).

If a stereo camera is used as a 3D camera for visually (passively) scanning the surroundings ahead of the vehicle, the depth-resolved image data (or the disparity image) can be used to generate a height map of said surroundings of the vehicle. The curve of this height map can now be evaluated along several lines (5) running transversely (2) to the direction of travel (1).

If a jump in height (7, 8) is detected along at least one of these lines, the relevant point/area in the height map can be assigned to an image point/area in a 2D image of an individual image recording unit of the stereo camera.

The image in FIG. 1, without the transverse lines used for scanning, could e.g. have been recorded by an individual image recording unit of the stereo camera. Before edge detection is then performed in the 2D image, the camera image may first be pre-processed: data synchronization, grayscale image conversion and noise reduction. The starting point for said edge detection is the result (image point or area) of the jumps in height determined earlier from the 3D image data. This is where a contour search starts during which a Canny edge operator is used to detect edges. The determined grayscale (or color) edges can be tracked in the forward direction (i.e. approximately in the direction of travel) into larger distances. Finally, contour matching may be performed to check whether the determined contours correspond to a roadside marking.

This approach has the advantage that the potential roadside markings determined from the 3D image data are verified, so that only image areas that actually include raised/lowered roadside markings are taken into account as candidates. For this purpose, it is not necessary to perform edge detection for image areas where no jumps in the height curve have been detected.

1. A method for determining a height profile of the surroundings of a vehicle by 3D camera, wherein the 3D camera records at least one image of the surroundings ahead of the vehicle, and wherein the image data of the 3D camera is used to detect at least one jump in a height curve of the surface of said surroundings transversely to the direction of travel of the vehicle.

2. The method according to claim 1, wherein the height curve is determined along a plurality of lines running transversely to the direction of travel.

3. The method according to claim 2, wherein the area of detection in which the height curve is determined along the plurality of lines running transversely to the direction of travel is limited in accordance with jumps in said height curve determined earlier.

4. The method according to claim 1, wherein an algorithm for edge detection is used to detect edges based on 2D image data which is provided by the 3D camera and constitutes a color and/or grayscale image, and said edges are taken into account when determining the height profile of the surroundings of the vehicle based on the 3D image data.

5. The method according to claim 1, wherein at least one roadway edge is detected taking into account the at least one determined jump in the height curve.

6. The method according to claim 5, wherein a raised roadside marking is detected based on a predefined minimum height of a jump in the height curve.

7. The method according to claim 6, wherein at least one of vehicle data and data relating to the surroundings is used to determine whether there is a risk that the vehicle will collide with a raised roadside marking, and if so, a warning is issued or the vehicle control system is manipulated in order to avoid the collision.

8. The method according to claim 5, wherein a lower level of the surroundings adjoining the roadway is detected based on a predefined minimum depth of a jump, at least one of vehicle data and data relating to the surroundings is used to determine whether there is a risk that the vehicle will run off the roadway, and if so, a warning is issued or the vehicle control system is manipulated in order to prevent the vehicle from leaving the roadway.

9. The method according to claim 6, wherein sloped and/or lowered curbstones can be detected based on changing jumps in height in the direction of travel if there are raised roadside marking, thus enabling the detection of driveways and/or drives running transversely to the roadway.

10. The method according to claim 6, wherein the vehicle control system is manipulated at least once during a stopping or parking process, so that the vehicle will be positioned parallel to and at a predefined lateral distance to a raised roadside marking.

11. The method according to claim 1, wherein the 3D camera is a stereo camera.

12. A device for determining a height profile of the surroundings of a vehicle, comprising a 3D camera, wherein evaluation means are provided for detecting at least one jump in the height curve of the surface of said surroundings transversely to the direction of travel of the vehicle.
